(19) United States
(12) Patent Application Publication
(10) Pub. No.: US 2026/0004570 A1
(43) Pub. Date: Jan. 1, 2026

(54) APPARATUS AND METHOD FOR RECOGNIZING POINTING GESTURE WITH COORDINATED EYE GAZE

(71) Applicant: ELECTRONICS AND TELECOMMUNICATIONS RESEARCH INSTITUTE, Daejeon (KR)

(72) Inventors: Cheol-Hwan YOO, Daejeon (KR); Moon-Ki BACK, Daejeon (KR); Jang-Hee YOO, Daejeon (KR)

(21) Appl. No.: 18/971,218

(22) Filed: Dec. 6, 2024

(30) Foreign Application Priority Data
Jun. 28, 2024 (KR) 10-2024-0085002

(51) Int. Cl. G06V 10/80; G06V 10/26; G06V 10/764; G06V 10/774; G06V 10/82; G06V 40/10; G06V 40/16; G06V 40/18

(52) U.S. Cl. CPC G06V 10/806; G06V 10/26; G06V 10/764; G06V 10/774; G06V 10/82; G06V 40/11; G06V 40/161; G06V 40/18

(57) ABSTRACT

Disclosed herein is an apparatus and method for recognizing a pointing gesture with coordinated eye gaze. The apparatus detects hand and face region images of a subject from a video input from a camera, extracts and encodes visual features of the hand and face region images, generates a visual fusion feature, in which a pointing gesture with or without coordinated eye gaze is classified, from the visual features of the hand and face region images, and learns a pointing gesture with coordinated eye gaze from the visual fusion feature by using a cross-entropy loss function.

### CROSS REFERENCE TO RELATED APPLICATION

This application claims the benefit of Korean Patent Application No. 10-2024-0085002, filed Jun. 28, 2024, which is hereby incorporated by reference in its entirety into this application.

### BACKGROUND OF THE INVENTION

### 1. Technical Field

The present disclosure relates generally to artificial intelligence and technology for recognizing gestures based on multimodal input, and more particularly to technology for recognizing a pointing gesture with coordinated eye gaze.

### 2. Description of Related Art

According to the U.S. Centers for Disease Control and Prevention (CDC), the prevalence of children with autism spectrum disorder (ASD) increased from 1 in 54 in 2016 to 1 in 36 in 2020 and continues to increase every year. Early diagnosis of children with ASD is very important in terms of not only providing an opportunity for the brain of a child to change into a normal form during a period of high plasticity but also preventing secondary neurological damage and the accumulation of behavioral problems. However, because current diagnostic systems rely mainly on labor-intensive manual tests performed by medical experts, this often leads to a problem of missing early diagnosis, which is an important factor in prognosis. In order to alleviate this problem, a wide range of technologies are being researched to support ASD diagnosis through AI-based automated analysis of various characteristics (e.g., characteristics of facial expressions, restricted and repetitive behaviors, etc.) of children with ASD. In addition to these indicators, pointing gestures in children typically emerge between 8 and 10 months of age and are primarily used to share social attention or interest. Therefore, a deficit in the ability to point to objects is known to be one of the key indicators in distinguishing children with ASD from children with Typical Development (TD).

However, there are some limitations regarding the detection of pointing gestures in children.

First, there is a significant lack of datasets specifically tailored for learning of pointing gestures of children, and the lack of training data from the target domain becomes a major factor in the performance degradation of conventional supervised-learning-based CNNs due to domain shift.

Also, most of the current diagnostic systems independently assess only a single indicator at a specific, predetermined time, so they have a limitation in assessing child's overall behavior patterns. In particular, with regard to pointing, most conventional techniques do not consider coordinated eye gaze when detecting pointing gestures, so they have a limitation in assessing child's comprehensive communication ability and cannot accurately assess how the behavior can be interpreted in social context.

Meanwhile, Korean Patent No. 10-1671784, titled “System and method for object detection”, discloses a system and method for detecting a hand region using skin color information in an image obtained from stereo cameras, detecting an object in the direction to which the finger points, and outputting haptic feedback on the distance of the detected object.

### SUMMARY OF THE INVENTION

An object the present disclosure is to provide a method for detecting a pointing gesture based on coordinated eye gaze in order to support diagnosis of children with autism spectrum disorder.

Another object of the present disclosure is to effectively detect a pointing gesture of a child by mitigating performance degradation caused by a domain gap in a deep-learning model and improving domain generalization performance.

A further object of the present disclosure is to automatically detect the presence or absence of a child's pointing gesture response through a structured diagnostic protocol such as social-interaction-inducing content.

In order to accomplish the above objects, an apparatus for recognizing a pointing gesture with coordinated eye gaze according to an embodiment of the present disclosure includes one or more processors and memory for storing at least one program executed by the one or more processors, and the at least one program detects hand and face region images of a subject in a video input from a camera, extracts and encodes visual features of the hand and face region images, generates a visual fusion feature, in which a pointing gesture with or without coordinated eye gaze is classified, from the visual features of the hand and face region images, and learns a pointing gesture with coordinated eye gaze from the visual fusion feature by using a cross-entropy loss function.

Here, the at least one program may detect a hand region by generating a preset 3D bounding box around a hand position of the subject and projecting an image within the 3D bounding box onto a 2D coordinate system.

Here, the at least one program may generate augmented hand region images by performing a random crop and a random horizontal flip for the detected hand region image.

Here, the at least one program may make feature vectors of visual features of the augmented hand region images become close to each other using a self-supervised learning scheme.

Here, the at least one program may generate the visual fusion feature classified into a pointing response with coordinated eye gaze, a pointing response without coordinated eye gaze, and no pointing response.

Here, the at least one program may learn the pointing gesture with coordinated eye gaze using a loss function for classification of the visual fusion feature and a loss function derived by the self-supervised learning scheme.

Here, the self-supervised learning scheme may learn class-specific features and domain-invariant features and train an entire network in an end-to-end manner.

Also, in order to accomplish the above objects, a method for recognizing a pointing gesture with coordinated eye gaze, performed by an apparatus for recognizing a pointing gesture with coordinated eye gaze, according to an embodiment of the present disclosure includes detecting hand and face region images of a subject in a video input from a camera, extracting and encoding visual features of the hand and face region images, generating a visual fusion feature, in which a pointing gesture with or without coordinated eye gaze is classified, from the visual features of the hand and face region images, and learning a pointing gesture with coordinated eye gaze from the visual fusion feature by using a cross-entropy loss function.

Here, the input video may be a recording of a response of the subject in a query-response form to social-interaction-inducing content for determining a subject's ability to socially communicate with others.

Here, detecting the hand and face region images may comprise detecting a hand region by generating a preset 3D bounding box around a hand position of the subject and by projecting an image within the 3D bounding box onto a 2D coordinate system.

Here, the method may further include, after detecting the hand and face region images, generating augmented hand region images by performing a random crop and a random horizontal flip for the detected hand region image.

Here, generating the augmented hand region images may comprise making feature vectors of visual features of the augmented hand region images become close to each other using a self-supervised learning scheme.

Here, generating the visual fusion feature may comprise generating the visual fusion feature classified into a pointing response with coordinated eye gaze, a pointing response without coordinated eye gaze, and no pointing response.

Here, learning the pointing gesture with coordinated eye gaze may comprise learning the pointing gesture with coordinated eye gaze using a loss function for classification of the visual fusion feature and a loss function derived by the self-supervised learning scheme.

Here, the self-supervised learning scheme may learn class-specific features and domain-invariant features and train an entire network in an end-to-end manner.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for recognizing a pointing gesture with coordinated eye gaze that performs a learning procedure according to an embodiment of the present disclosure;

FIG. 2 is a block diagram illustrating an apparatus for recognizing a pointing gesture with coordinated eye gaze that performs an inference procedure according to an embodiment of the present disclosure;

FIG. 3 is a view illustrating a framework at a learning step according to an embodiment of the present disclosure;

FIG. 4 is a view illustrating a framework at an inference step according to an embodiment of the present disclosure;

FIGS. 5 to 7 are views illustrating social-interaction-inducing content for recognizing a pointing gesture according to an embodiment of the present disclosure;

FIGS. 8 to 15 are views illustrating detection of the presence or absence of a child's pointing gesture response through social-interaction-inducing content according to an embodiment of the present disclosure, in which it can be seen that child's pointing behavior is recognized in FIGS. 8 to 11 and that no pointing is recognized in FIGS. 12 to 15;

FIG. 16 is a graph illustrating performance comparison between pointing gesture recognition models according to an embodiment of the present disclosure;

FIG. 17 is a flowchart illustrating a method for recognizing a pointing gesture with coordinated eye gaze to perform a learning step according to an embodiment of the present disclosure;

FIG. 18 is a flowchart illustrating a method for recognizing a pointing gesture with coordinated eye gaze to perform an inference step according to an embodiment of the present disclosure; and

FIG. 19 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

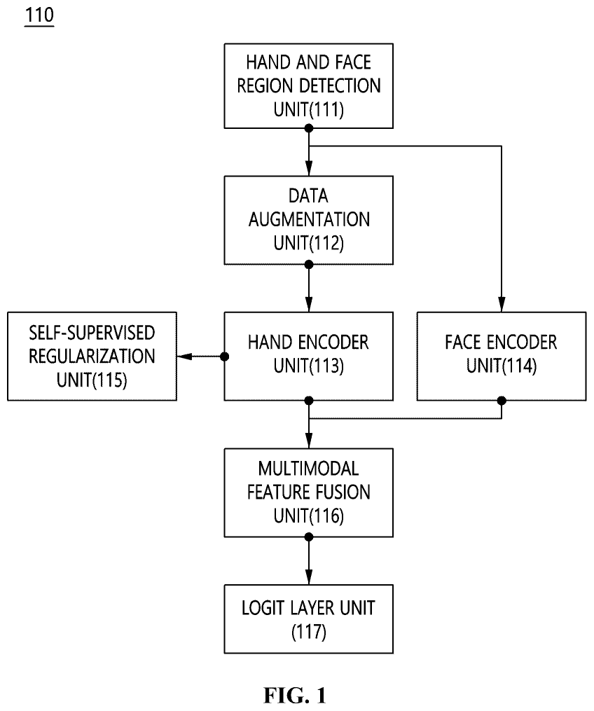

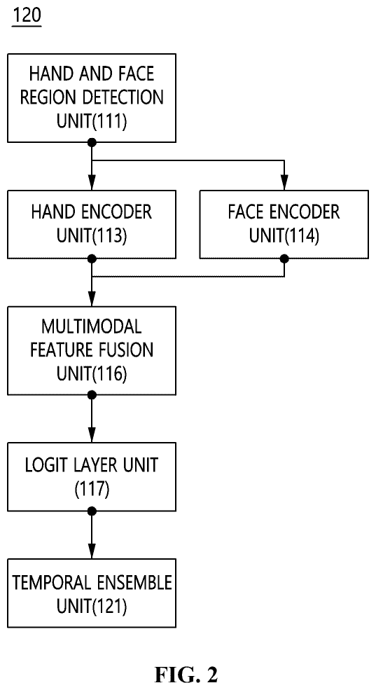

FIG. 1 is a block diagram illustrating an apparatus for recognizing a pointing gesture with coordinated eye gaze that performs a learning procedure according to an embodiment of the present disclosure. FIG. 2 is a block diagram illustrating an apparatus for recognizing a pointing gesture with coordinated eye gaze that performs an inference procedure according to an embodiment of the present disclosure.

Referring to FIGS. 1 and 2, the apparatus for recognizing a pointing gesture with coordinated eye gaze according to an embodiment of the present disclosure includes a hand and face region detection unit 111, a data augmentation unit 112, a hand encoder unit 113, a face encoder unit 114, a self-supervised regularization unit 115, a multimodal feature fusion unit 116, a logit layer unit 117, and a temporal ensemble unit 121.

First, the apparatus for recognizing a pointing gesture with coordinated eye gaze that performs a learning procedure illustrated in FIG. 1 will be described.

The hand and face region detection unit 111, the data augmentation unit 112, the hand encoder unit 113, the face encoder unit 114, the self-supervised regularization unit 115, the multimodal feature fusion unit 116, and the logit layer unit 117 may be used at a learning step 110.

The hand and face region detection unit 111 may detect hand region D_{H}(x) and face region D_{F}(x) of a child in an input video frame x, which is input from a camera such as a webcam, an IP camera, Kinect, or the like, using a hand detector D_{H}(·) and a face detector D_{F}(·).

Here, the input video may be a recording of a response in a query-response form to social-interaction-inducing content for determining a child's ability to socially communicate with others.

Here, the hand and face region detection unit 111 may drive a deep-learning network to focus on only the hand region and the face region by removing unnecessary background and body features.

Here, the hand and face region detection unit 111 may perform human-pose-based hand region detection in order to detect only the hand region of a child when there are multiple people in the video.

Here, the hand and face region detection unit 111 may lift 2D body coordinates inferred through conventional OpenPose or the like to a 3D coordinate system using additional depth information and camera parameter information, calculate the 3D bone length between shoulders, and designate the person with the shortest bone length in the video as the child to be analyzed.

Here, the hand and face region detection unit 111 generates a 3D bounding box of a fixed size around the 3D hand position in order to detect the hand region and then projects the image within the 3D bounding box onto a 2D image coordinate system, thereby performing hand region detection robust to a scale, occlusion, and the like.

Here, the hand and face region detection unit 111 may use RetinaFace that is well known in relation to face region detection.

The data augmentation unit 112 may generate a k-th randomly augmented image

$${x}_{k}^{H}$$

for the hand region D_{H}(x), among the regions detected by the hand and race region detection unit 111, as shown in Equation (1) below:

$${x}_{k}^{H} = {T}_{k} ( {D}_{H} ( x ) ) \qquad ( 1 )$$

In Equation (1), Tₖ(⋅), k=1, . . . , N indicates transformation functions, and in the present disclosure, transformation functions for a random crop of size 224 and a random horizontal flip may be employed.

Here, the first transformation function T₁(⋅) may transfer the input image without any special transformation so as to be fused with the facial region features for coordinated eye gaze.

The hand encoder unit 113 may encode the image corresponding to the randomly augmented hand region to visual embedding features in order to learn domain-invariant features.

The self-supervised regularization unit 115 (self-supervised regularizing block (SRB)) may make feature vectors close to each other, as shown in Equation (2):

$${f}_{k}^{H} = {ε}_{k}^{H} ( {x}_{k}^{H} ; {θ}_{k}^{H} ) , {L}_{r e g} = SRB ( {f}_{1}^{H} , … , {f}_{k}^{H} ) \qquad ( 2 )$$

Here,

$${ε}_{k}^{H} ( \cdot ) , k = 1 , … , N$$

indicates the encoder unit with learnable parameters

$${θ}_{k}^{H} ,$$

and ResNet-50, Vision Transformer, or the like may be adopted as the encoder.

It can be seen that

$${f}_{k}^{H} , k = 1 , … , N$$

indicates the visual embedding features encoded through the hand encoder unit 113.

L_{reg} indicates self-supervised regularization loss derived by the self-supervised regularization unit 115. Here, N, which is the number of applied transformations, may be extended to an arbitrary size, but according to most self-supervised learning methods, it is set to 2 in the present disclosure.

Also, the self-supervised regularization unit 115 may use arbitrary self-supervised learning (SSL) schemes.

Here, the self-supervised regularization unit 115 may use self-supervised learning schemes such as SimSiam and Bootstrap your own latent (BYOL), which do not require negative samples, for usability and scalability.

The face encoder unit 114 may extract a visual feature

$${f}_{1}^{F}$$

corresponding to a face region for the detected face region D_{F}(x) in order to link the coordinated eye gaze information to the hand region information for recognizing a pointing gesture.

The multimodal feature fusion unit 116 may fuse visual features corresponding to the hand region and visual features corresponding to the face region into visual fusion features.

Here, the multimodal feature fusion unit 116 may adopt an additional projection layer for a concatenation of simple feature vectors or alignment of features in order to fuse features of different modalities.

Here, the multimodal feature fusion unit 116 identifies a specific behavior pattern or correlation by analyzing the interaction of various indicators through the fused complex information, thereby performing more in-depth diagnosis.

For example, the multimodal feature fusion unit 116 combines additional eye gaze information with information about whether a child positively responds to a pointing gesture based on the hand region and divides the pointing behavior, thereby performing more sophisticated classification including information about the presence or absence of coordinated eye gaze (a pointing response with coordinated eye gaze, a pointing response without coordinated eye gaze, and no pointing response).

The logit layer unit 117 may perform pointing gesture recognition task learning through Equation (3) using a binary cross-entropy loss function.

$${y}_{1} = P ( G ( {ε}_{1}^{H} ( {x}_{1}^{H} ; {θ}_{1}^{H} ) , {ε}_{1}^{F} ( {x}_{1}^{F} ; {θ}_{1}^{F} ) ; {θ}_{G} ) ; {θ}_{P} ) , {L}_{c} = - {\sum }_{i}^{3} {t}_{i} {log ( s ( {y}_{1} ) )}_{i} \qquad ( 3 )$$

Here, G indicates the multimodal feature fusion unit 116 with a learnable parameter θ_{G}, P indicates the logit layer unit 117 with a learnable parameter θ_{P}, s indicates the softmax function, and tᵢ indicates the i-th element of one-hot ground truth vector t.

Finally, the total loss function for training the network proposed in the present disclosure is configured with a classification loss function L_{c} for classification of the visual fusion features and a loss function L_{reg} derived by the self-supervised regularization unit 115, and may be defined as shown in Equation (4):

$${L}_{total} = {L}_{c} + λ {L}_{r e g} \qquad ( 4 )$$

Here, λ, which is a user parameter for adjusting the balance between the two loss functions, is set to 0.5 in the present disclosure.

The self-supervised regularization unit 115 is used for the additional constraint for learning as described above, so that the deep-learning network may learn not only class-specific features but also domain-invariant features.

Here, the self-supervised regularization unit 115 may also be compatible with any self-supervised learning method, and the entire network may perform learning in an end-to-end manner.

Next, the apparatus for recognizing a pointing gesture with coordinated eye gaze that performs an inference procedure illustrated in FIG. 2 will be described.

At the inference step 120 of the network trained through the above-described method, the hand and face region detection unit 111, the hand encoder unit 113, the face encoder unit 114, the multimodal feature fusion unit 116, the logit layer unit 117, and the temporal ensemble unit 121, among the deep-learning layers trained in the learning step 110, may be used.

The hand and face region detection unit 111 may detect a hand region D_{H}(x) and face region D_{F}(x) of a child in an input video frame x, which is input from a camera such as a webcam, an IP camera, Kinect, or the like, using a hand detector D_{H}(⋅) and a face detector D_{F}(⋅).

Here, the input video may be a recording of a response in a query-response form to social-interaction-inducing content for determining a child's ability to socially communicate with others.

Here, the hand and face region detection unit 111 may drive a deep-learning network to focus on only the hand region and the face region by removing unnecessary background and body features.

Here, the hand and face region detection unit 111 may perform human-pose-based hand region detection in order to detect only the hand region of a child when there are multiple people in the video.

Here, the hand and face region detection unit 111 may lift 2D body coordinates inferred through conventional OpenPose or the like to a 3D coordinate system using additional depth information and camera parameter information, calculate the 3D bone length between shoulders, and designate the person with the shortest bone length in the video as the child to be analyzed.

Here, the hand and face region detection unit 111 generates a 3D bounding box of a fixed size around the 3D hand position in order to detect the hand region and then projects the image within the 3D bounding box onto a 2D image coordinate system, thereby performing hand region detection robust to a scale, occlusion, and the like.

Here, the hand and face region detection unit 111 may use RetinaFace that is well known in relation to face region detection.

The hand encoder unit 113 may encode the image corresponding to a randomly augmented hand region to visual embedding features in order to infer domain-invariant features.

The face encoder unit 114 may extract a visual feature

$${f}_{1}^{F}$$

corresponding to a face region for the detected face region D_{F}(x) in order to link the coordinated eye gaze information to the hand region information for recognizing a pointing gesture.

The multimodal feature fusion unit 116 may fuse visual features corresponding to the hand region and visual features corresponding to the face region into visual fusion features.

Here, the multimodal feature fusion unit 116 may adopt an additional projection layer for a concatenation of simple feature vectors or alignment of features in order to fuse features of different modalities.

Here, the multimodal feature fusion unit 116 identifies a specific behavior pattern or correlation by analyzing the interaction of various indicators through the fused complex information, thereby performing more in-depth diagnosis.

For example, the multimodal feature fusion unit 116 combines additional eye gaze information with information about whether a child positively responds to a pointing gesture based on the hand region and divides the pointing behavior, thereby performing more sophisticated classification including information about the presence or absence of coordinated eye gaze (a pointing response with coordinated eye gaze, a pointing response without coordinated eye gaze, and no pointing response).

The logit layer unit 117 may infer a pointing gesture from probability values for respective classes (a pointing response with coordinated eye gaze, a pointing response without coordinated eye gaze, and no pointing response).

The temporal ensemble unit 121 may infer a pointing gesture using a simple voting scheme in order to reduce the risk of frame-level prediction vulnerable to noise and to use temporal information of an input sequence.

Specifically, the temporal ensemble unit 121 collects the current frame-level prediction and the previous frame-level prediction using a temporal sliding window, thereby predicting a final video-level result for the pointing gesture as shown in Equation (5):

$$y = A ( {y}_{1}^{t} , {y}_{1}^{t - 1} , … , {y}_{1}^{t - T} ) \qquad ( 5 )$$

In Equation 5, A(⋅) indicates the temporal ensemble unit 121, and in the present disclosure, mean pooling is used. t indicates the current time step, and T indicates the number of previous frames stored in the temporal sliding window and is set to 2 in the example of the present disclosure.

That is, when the most recent three or more consecutive frames are predicted to contain a pointing gesture, the temporal ensemble unit 121 may finally determine that the child's pointing gesture positive response has occurred.

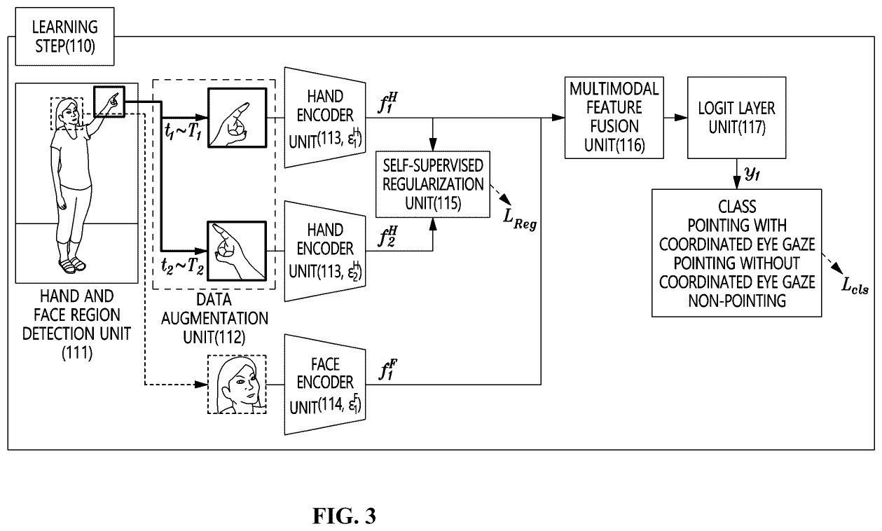

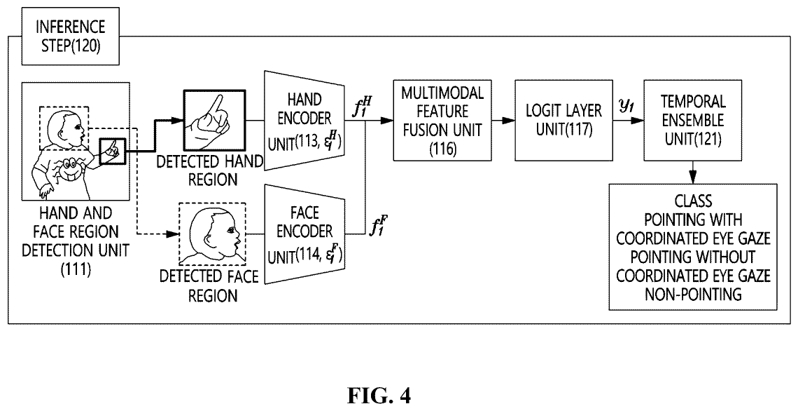

FIG. 3 is a view illustrating a framework at a learning step according to an embodiment of the present disclosure. FIG. 4 is a view illustrating a framework at an inference step according to an embodiment of the present disclosure.

Referring to FIGS. 3 and 4, it can be seen that the operation process of the apparatus for recognizing a pointing gesture with coordinated eye gaze at the learning step and inference step explained in FIGS. 1 and 2 is illustrated.

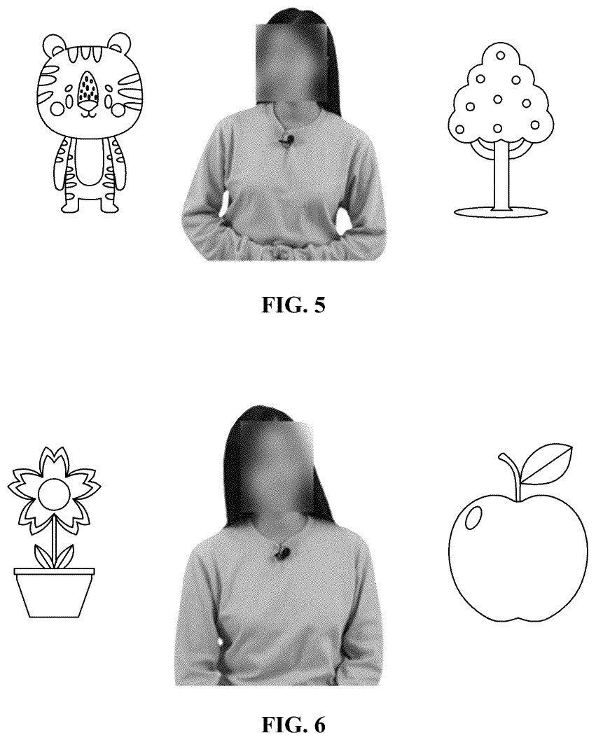

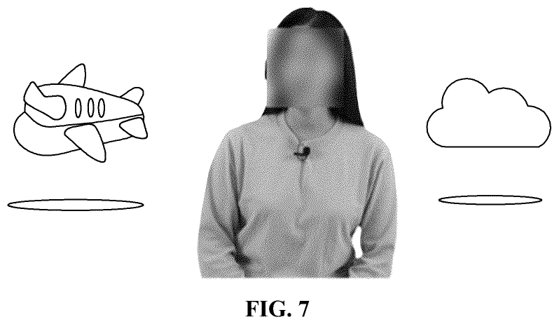

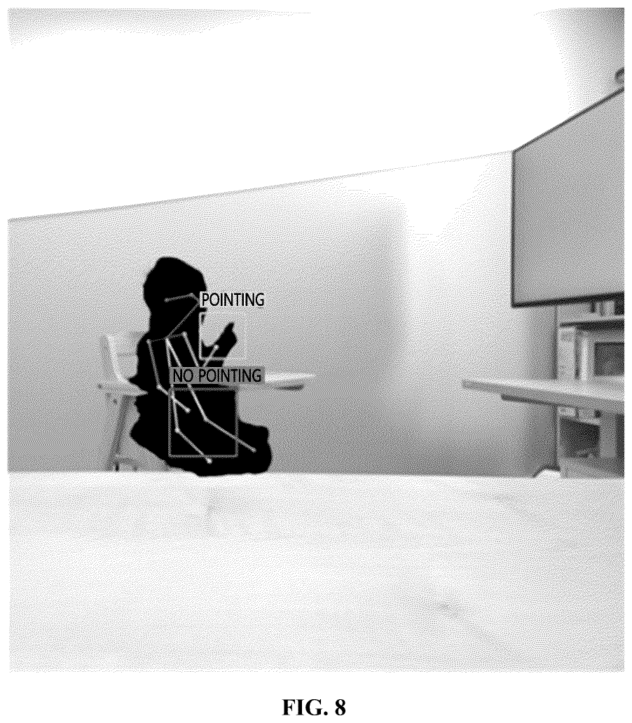

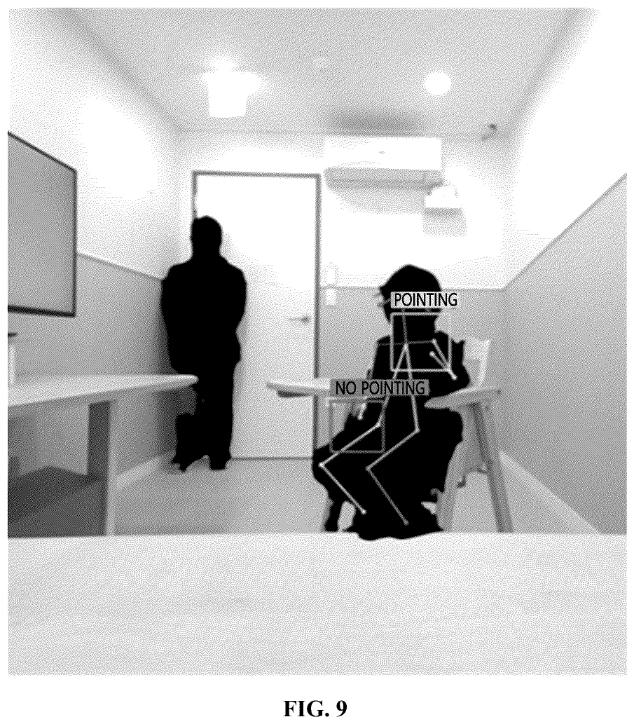

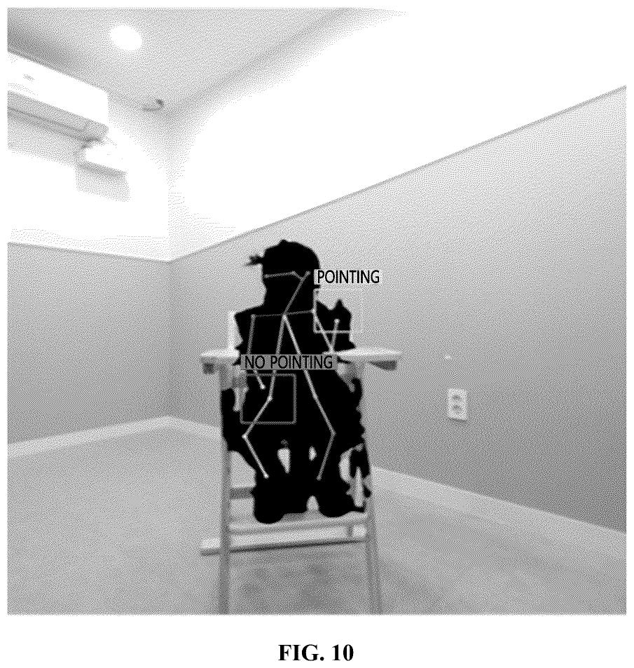

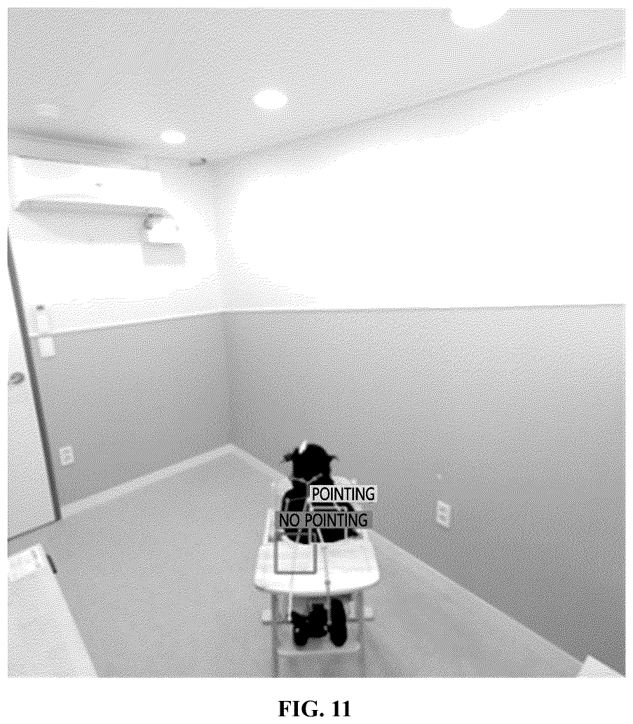

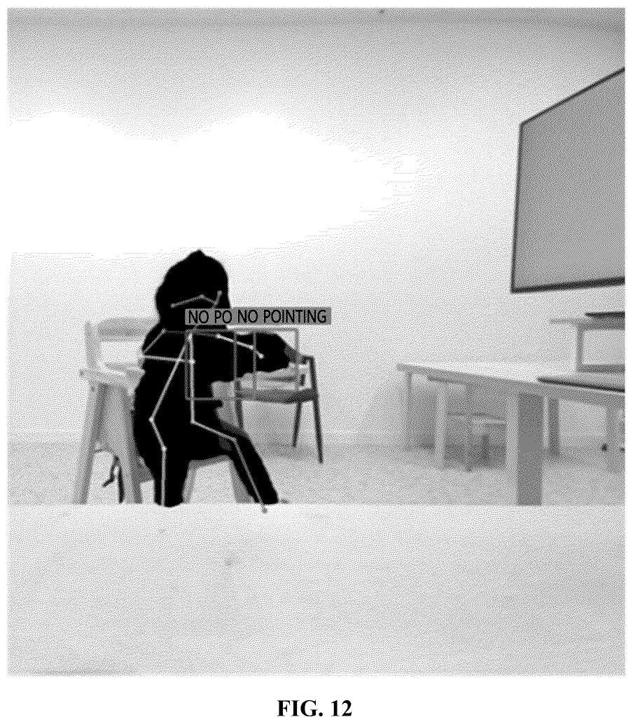

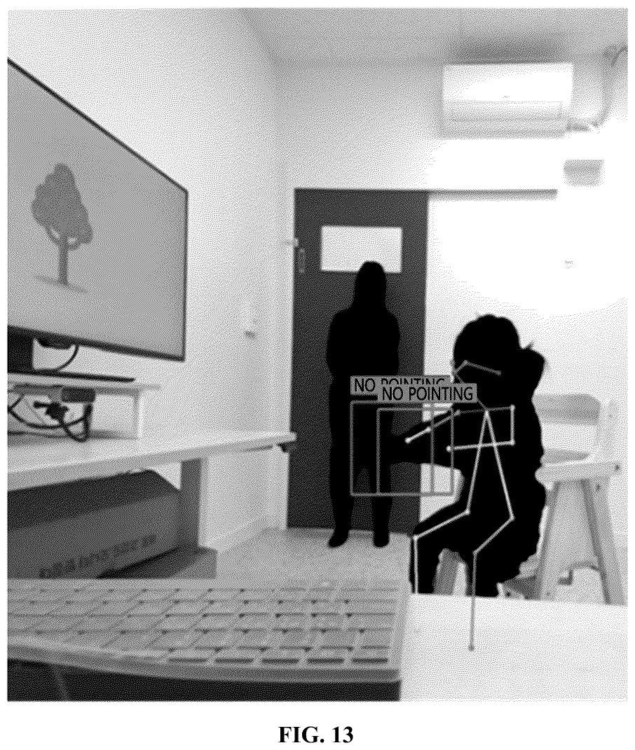

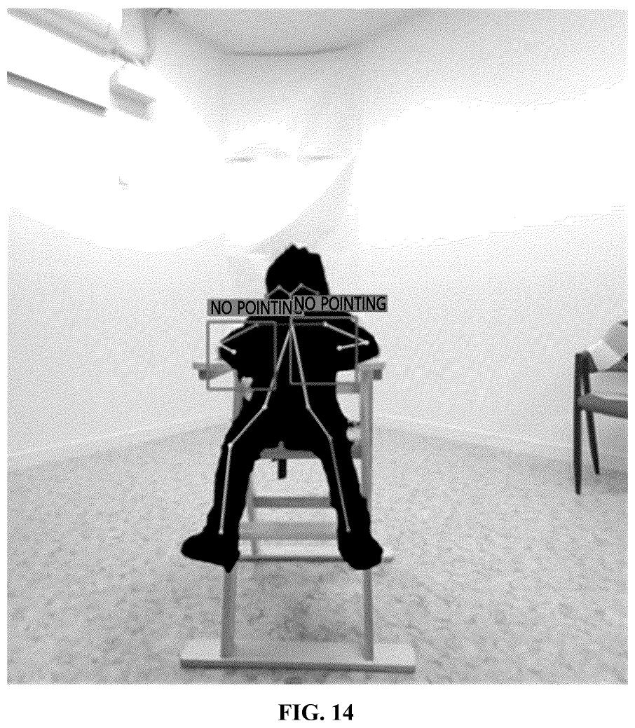

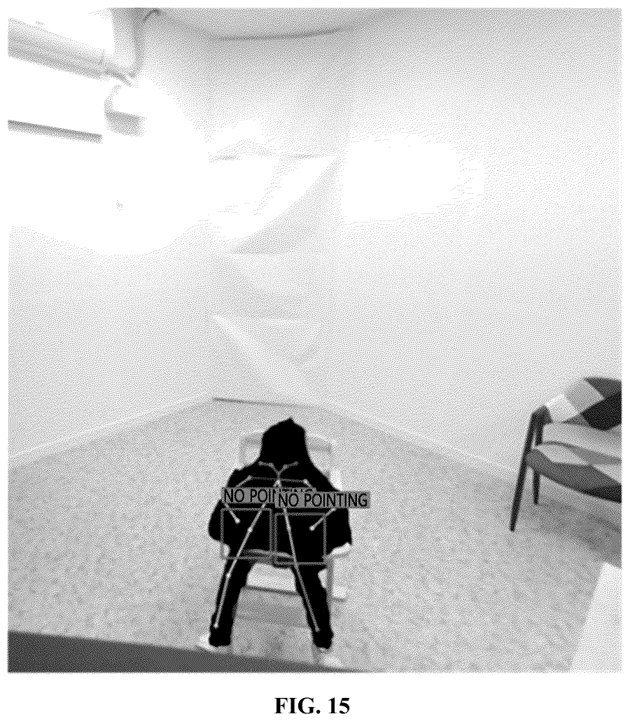

FIGS. 5 to 7 are views illustrating social-interaction-inducing content for recognizing a pointing gesture according to an embodiment of the present disclosure. FIGS. 8 to 15 are views illustrating detection of the presence or absence of a child's pointing gesture response through the social-interaction-inducing content according to an embodiment of the present disclosure.

Referring to FIGS. 5 to 7, the social-interaction-inducing content may be designed to observe whether a child positively responds to a pointing gesture within a given time by prompting a response through a query-response form in order to determine the child's ability to socially communicate with others.

Also, each detailed factor is tried a total of three times to reduce the noise caused by external factors and to improve the reliability of diagnosis, and specifically, a child's response may be induced through instructions of a moderator, such as “Look for a tiger”, “Look for an apple”, and “Look for an airplane”, in the content video.

Referring to FIGS. 8 to 15, it can be seen that a child's pointing gesture response is observed through the social-interaction-inducing content.

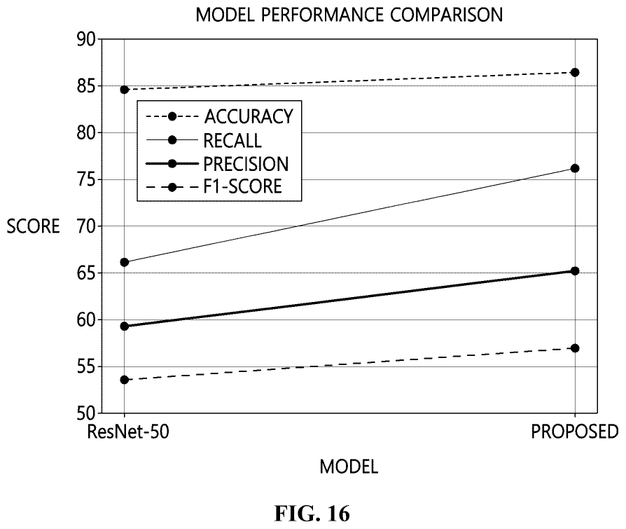

FIG. 16 is a graph illustrating performance comparison between pointing gesture recognition models according to an embodiment of the present disclosure.

Referring to FIG. 16, it can be seen that a pointing gesture recognition network is trained using the NTU RBD+D dataset (training image: 48.7K, validation image: 12.2K) that is reconfigured for a task by applying a SimSiam-based self-supervised regularization scheme, and then cross-dataset inference is performed for 40 children with ASD or TD, collected through social-interaction-inducing content, using the model of the present disclosure and the vanilla ResNet-50 model.

Here, it can be seen that the model of the present disclosure exhibits improved recognition performance in all indicators (accuracy, recall, precision, and F1-score), compared to vanilla ResNet-50.

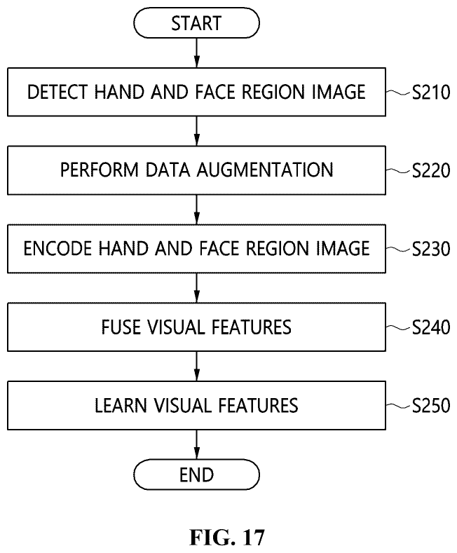

FIG. 17 is a flowchart illustrating a method for recognizing a pointing gesture with coordinated eye gaze to perform a learning step according to an embodiment of the present disclosure.

Referring to FIG. 17, in the method for recognizing a pointing gesture with coordinated eye gaze to perform a learning step according to an embodiment of the present disclosure, first, hand and face region images may be detected at step S210.

That is, at step S210, the hand region D_{H}(x) and face region D_{F}(x) of a child may be detected in an input video frame x, which is input from a camera such as a webcam, an IP camera, Kinect, or the like, using a hand detector D_{H}(⋅) and a face detector D_{F}(⋅).

Here, the input video may be a recording of a response in a query-response form to social-interaction-inducing content for determining a child's ability to socially communicate with others.

Here, at step S210, a deep-learning network may be driven to focus on only the hand region and the face region by removing unnecessary background and body features.

Here, at step S210, human-pose-based hand region detection may be performed in order to detect only the hand region of a child when there are multiple people in the video.

Here, at step S210, 2D body coordinates inferred through conventional OpenPose or the like may be lifted to a 3D coordinate system using additional depth information and camera parameter information, the 3D bone length between shoulders may be calculated, and the person with the shortest bone length in the video may be designated as the child to be analyzed.

Here, at step S210, after a 3D bounding box of fixed size is generated around the 3D hand position in order to detect the hand region, the image within the 3D bounding box is projected onto a 2D image coordinate system, whereby hand region detection robust to a scale, occlusion, and the like may be performed.

Here, at step S210, well-known RetinaFace or the like may be used for detection of the face region.

Also, in the method for recognizing a pointing gesture with coordinated eye gaze to perform a learning step according to an embodiment of the present disclosure, data augmentation may be performed at step S220.

$${x}_{k}^{H}$$

for the hand region That is, at step S220, a k-th randomly augmented image D_{H}(x), among the detected hand and face regions, may be generated as shown in Equation (1).

In Equation (1),

$${T}_{k} ( \cdot ) , k = 1 , … , N$$

indicates transformation functions, and in the present disclosure, transformation functions for a random crop of size 224 and a random horizontal flip may be adopted.

Here, the first transformation function T₁(⋅) may transfer the input image without any special transformation so as to be fused with the facial region features for coordinated eye gaze.

Also, in the method for recognizing a pointing gesture with coordinated eye gaze to perform a learning step according to an embodiment of the present disclosure, the hand and face region images may be encoded at step S230.

That is, at step S230, the image corresponding to the randomly augmented hand region may be encoded to visual embedding features in order to learn domain-invariant features.

Here, at step S230, feature vectors may be made close to each other, as shown in Equation (2).

Here,

$${ε}_{k}^{H} ( \cdot ) , k = 1 , … , N$$

indicates the encoder unit with learnable parameters

$${θ}_{k}^{H} ,$$

and ResNet-50, Vision Transformer, or the like may be adopted as the encoder.

It can be seen that

$${f}_{k}^{H} , k = 1 , … , N$$

indicates the visual embedding features encoded through the hand encoder unit 113.

L_{reg} indicates self-supervised regularization loss derived by the self-supervised regularization unit 115. Here, N, which is the number of applied transformations, may be extended to an arbitrary size, but according to most self-supervised learning methods, it is set to 2 in the present disclosure.

Also, at step S230, arbitrary self-supervised learning (SSL) schemes may be used.

Here, at step S230, self-supervised learning schemes such as SimSiam and Bootstrap your own latent (BYOL), which do not require negative samples, may be used for usability and scalability.

Also, at step S230, a visual feature

$${f}_{1}^{F}$$

corresponding to a face region may be extracted for the detected face region D_{F}(x) in order to link the coordinated eye gaze information to the hand region information for recognizing a pointing gesture.

Also, in the method for recognizing a pointing gesture with coordinated eye gaze to perform a learning step according to an embodiment of the present disclosure, the visual features may be fused into visual fusion features at step S240.

That is, at step S240, the visual features corresponding to the hand region and the visual features corresponding to the face region may be fused into visual fusion features.

Here, at step S240, an additional projection layer for a concatenation of simple feature vectors or alignment of features may be adopted in order to fuse features of different modalities.

Here, at step S240, a specific behavior pattern or correlation may be identified by analyzing the interaction of various indicators through the fused complex information, whereby more in-depth diagnosis may be performed.

For example, at step S240, information about whether a child positively responds to a pointing gesture based on the hand region is combined with additional eye gaze information to divide the pointing behavior, whereby more sophisticated classification including information about the presence or absence of coordinated eye gaze (a pointing response with coordinated eye gaze, a pointing response without coordinated eye gaze, and no pointing response) may be performed.

Also, in the method for recognizing a pointing gesture with coordinated eye gaze to perform a learning step according to an embodiment of the present disclosure, the visual features may be learned at step S250.

That is, at step S250, using a binary cross-entropy loss function, pointing gesture recognition task learning may be performed through Equation (3).

Here, G indicates the multimodal feature fusion unit 116 with a learnable parameter θ_{G}, P indicates the logit layer unit 117 with a learnable parameter θ_{P}, s indicates the softmax function, and tᵢ indicates the i-th element of one-hot ground truth vector t.

Finally, the total loss function for training the network proposed in the present disclosure is configured with a classification loss function L_{c} for classification of the visual fusion features and a loss function L_{reg} derived by the self-supervised regularization unit 115, and may be defined as shown in Equation (4).

Here, A, which is a user parameter for adjusting the balance between the two loss functions, is set to 0.5 in the present disclosure.

Here, at step S250, the additional constraint for learning is used as described above, whereby the deep-learning network may learn not only class-specific features but also domain-invariant features.

Here, step S250 may also be compatible with any self-supervised learning method, and the entire network may perform learning in an end-to-end manner.

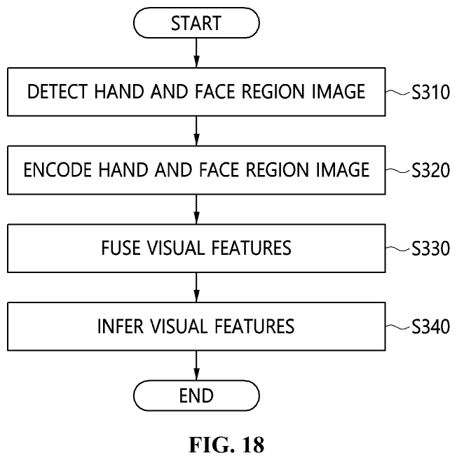

FIG. 18 is a flowchart illustrating a method for recognizing a pointing gesture with coordinated eye gaze to perform an inference step according to an embodiment of the present disclosure.

Referring to FIG. 18, in the method for recognizing a pointing gesture with coordinated eye gaze to perform an inference step according to an embodiment of the present disclosure, first, hand and face region images may be detected at step S310.

That is, at step S310, the hand region D_{H}(x) and face region D_{F}(x) of a child may be detected in an input video frame x, which is input from a camera such as a webcam, an IP camera, Kinect, or the like, using a hand detector D_{H}(⋅) and a face detector D_{F}(⋅).

Here, the input video may be a recording of a response in a query-response form to social-interaction-inducing content for determining a child's ability to socially communicate with others.

Here, at step S310, a deep-learning network may be driven to focus on only the hand region and the face region by removing unnecessary background and body features.

Here, at step S310, human-pose-based hand region detection may be performed in order to detect only the hand region of a child when there are multiple people in the video.

Here, at step S310, 2D body coordinates inferred through conventional OpenPose or the like may be lifted to a 3D coordinate system using additional depth information and camera parameter information, the 3D bone length between shoulders may be calculated, and the person with the shortest bone length in the video may be designated as the child to be analyzed.

Here, at step S310, a 3D bounding box of a fixed size is generated around the 3D hand position for detection of the hand region, and the image within the 3D bounding box is projected onto a 2D image coordinate system, whereby hand region detection robust to a scale, occlusion, and the like may be performed.

Here, at step S310, well-known RetinaFace, or the like may be used for detection of the face region.

Also, in the method for recognizing a pointing gesture with coordinated eye gaze to perform an inference step according to an embodiment of the present disclosure, the hand and face region images may be encoded at step S320.

That is, at step S320, the image corresponding to a randomly augmented hand region may be encoded to visual embedding features in order to infer domain-invariant features.

Here, at step S320, a visual feature

$${f}_{1}^{F}$$

corresponding to a race region may be extracted for the detected face region D_{F}(x) in order to link the coordinated eye gaze information to the hand region information for recognizing a pointing gesture.

Also, in the method for recognizing a pointing gesture with coordinated eye gaze to perform an inference step according to an embodiment of the present disclosure, the visual features may be fused into visual fusion features at step S330.

That is, at step S330, the visual features corresponding to the hand region and the visual features corresponding to the face region may be fused into visual fusion features.

Here, at step S330, an additional projection layer for a concatenation of simple feature vectors or alignment of features may be adopted in order to fuse features of different modalities.

Here, at step S330, a specific behavior pattern or correlation is identified by analyzing the interaction of various indicators through the fused complex information, whereby more in-depth diagnosis may be performed.

For example, at step S330, information about whether a child positively responds to a pointing gesture based on the hand region is combined with additional eye gaze information to divide the pointing behavior, whereby more sophisticated classification including information about the presence or absence of coordinated eye gaze (a pointing response with coordinated eye gaze, a pointing response without coordinated eye gaze, and no pointing response) may be performed.

Also, in the method for recognizing a pointing gesture with coordinated eye gaze to perform an inference step according to an embodiment of the present disclosure, the visual features may be inferred at step S340.

That is, at step S340, a pointing gesture may be inferred from probability values for respective classes (a pointing response with coordinated eye gaze, a pointing response without coordinated eye gaze, and no pointing response).

Here, at step S340, a pointing gesture may be inferred using a simple voting scheme in order to reduce the risk of frame-level prediction vulnerable to noise and to use temporal information of an input sequence.

Specifically, at step S340, the current frame-level prediction and the previous frame-level prediction are collected using a temporal sliding window, whereby a final video-level result for the pointing gesture may be predicted as shown in Equation (5).

In Equation 5, A(⋅) indicates the temporal ensemble unit 121, and in the present disclosure, mean pooling is used. t indicates the current time step, and T indicates the number of previous frames stored in the temporal sliding window and is set to 2 in the example of the present disclosure.

That is, at step S340, when the most recent three or more consecutive frames are predicted to contain a pointing gesture, it may be finally determined that the child's pointing gesture positive response has occurred.

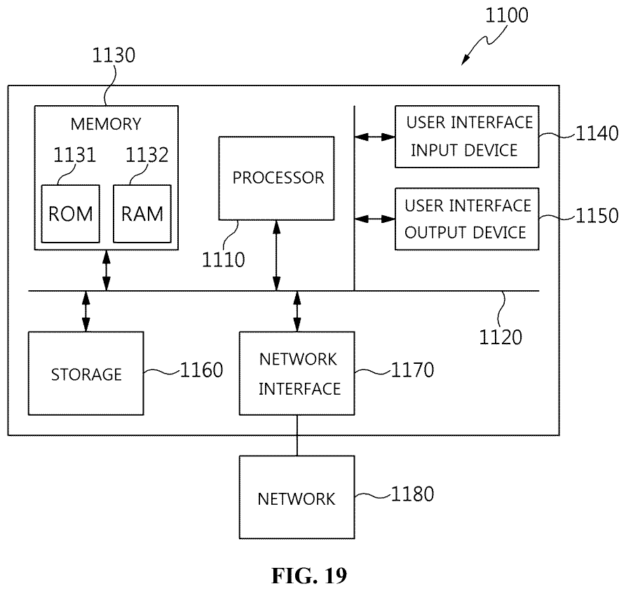

FIG. 19 is a view illustrating a computer system according to an embodiment of the present disclosure.

Referring to FIG. 19, the apparatus 100 for recognizing a pointing gesture with coordinated eye gaze according to an embodiment of the present disclosure may be implemented in a computer system 1100 including a computer-readable recording medium. As illustrated in FIG. 19, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for recognizing a pointing gesture with coordinated eye gaze according to an embodiment of the present disclosure includes one or more processors 1110 and memory 1130 for storing at least one program executed by the one or more processors 1110, and the at least one program detects hand and face region images of a subject in a video input from a camera, extracts and encodes visual features of the hand and face region images, and generates a visual fusion feature, in which a pointing gesture with or without coordinated eye gaze is classified, from the visual features of the hand and face region images, and learns a pointing gesture with coordinated eye gaze based on the visual fusion feature by using a cross-entropy loss function.

Here, the input video may be a recording of a response of the subject in a query-response form to social-interaction-inducing content for determining the subject's ability to socially communicate with others.

Here, the at least one program may generate a preset 3D bounding box around the hand position of the subject and detect the hand region by projecting the image within the 3D bounding box onto a 2D coordinate system.

Here, the at least one program may generate augmented hand region images by performing a random crop and a random horizontal flip for the detected hand region image.

Here, the at least one program may make the feature vectors of the visual features of the augmented hand region images become close to each other using a self-supervised learning scheme.

Here, the at least one of the program may generate the visual fusion feature classified into a pointing response with coordinated eye gaze, a pointing response without coordinated eye gaze, and no pointing response.

Here, the at least one program may learn the pointing gesture with coordinated eye gaze using a loss function for classification of the visual fusion feature and a loss function derived by the self-supervised learning scheme.

Here, the self-supervised learning scheme may learn class-specific features and domain-invariant features and train the entire network in an end-to-end manner.

The present disclosure may provide a method for detecting a pointing gesture based on coordinated eye gaze in order to support diagnosis of children with autism spectrum disorder.

Also, the present disclosure may effectively detect a pointing gesture of a child by mitigating performance degradation caused by a domain gap in a deep-learning model and improving domain generalization performance.

Also, the present disclosure may automatically detect the presence or absence of a child's pointing gesture response through a structured diagnostic protocol such as social-interaction-inducing content.

As described above, the apparatus and method for recognizing a pointing gesture with coordinated eye gaze according to the present disclosure are not limitedly applied to the configurations and operations of the above-described embodiments, but all or some of the embodiments may be selectively combined and configured, so the embodiments may be modified in various ways.

What is claimed is:

1. An apparatus for recognizing a pointing gesture with coordinated eye gaze, comprising:
one or more processors; and
memory for storing at least one program executed by the one or more processors,
wherein the at least one program
detects hand and face region images of a subject in a video input from a camera,
extracts and encodes visual features of the hand and face region images,
generates a visual fusion feature, in which a pointing gesture with or without coordinated eye gaze is classified, from the visual features of the hand and face region images, and
learns a pointing gesture with coordinated eye gaze from the visual fusion feature by using a cross-entropy loss function.

2. The apparatus of claim 1, wherein the input video is a recording of a response of the subject in a query-response form to social-interaction-inducing content for determining a subject's ability to socially communicate with others.

3. The apparatus of claim 1, wherein the at least one program generates a preset 3D bounding box around a hand position of the subject and projects an image within the 3D bounding box onto a 2D coordinate system, thereby detecting a hand region.

4. The apparatus of claim 1, wherein the at least one program generates augmented hand region images by performing a random crop and a random horizontal flip for the detected hand region image.

5. The apparatus of claim 4, wherein the at least one program makes feature vectors of visual features of the augmented hand region images become close to each other using a self-supervised learning scheme.

6. The apparatus of claim 5, wherein the at least one program generates the visual fusion feature classified into a pointing response with coordinated eye gaze, a pointing response without coordinated eye gaze, and no pointing response.

7. The apparatus of claim 6, wherein the at least one program learns the pointing gesture with coordinated eye gaze using a loss function for classification of the visual fusion feature and a loss function derived by the self-supervised learning scheme.

8. The apparatus of claim 7, wherein the self-supervised learning scheme learns class-specific features and domain-invariant features and trains an entire network in an end-to-end manner.

9. A method for recognizing a pointing gesture with coordinated eye gaze, performed by an apparatus for recognizing a pointing gesture with coordinated eye gaze, comprising:
detecting hand and face region images of a subject in a video input from a camera;
extracting and encoding visual features of the hand and face region images;
generating a visual fusion feature, in which a pointing gesture with or without coordinated eye gaze is classified, from the visual features of the hand and face region images; and
learning a pointing gesture with coordinated eye gaze from the visual fusion feature by using a cross-entropy loss function.

10. The method of claim 9, wherein the input video is a recording of a response of the subject in a query-response form to social-interaction-inducing content for determining a subject's ability to socially communicate with others.

11. The method of claim 9, wherein detecting the hand and face region images comprises detecting a hand region by generating a preset 3D bounding box around a hand position of the subject and by projecting an image within the 3D bounding box onto a 2D coordinate system.

12. The method of claim 9, further comprising:
after detecting the hand and face region images,
generating augmented hand region images by performing a random crop and a random horizontal flip for the detected hand region image.

13. The method of claim 12, wherein generating the augmented hand region images comprises making feature vectors of visual features of the augmented hand region images become close to each other using a self-supervised learning scheme.

14. The method of claim 13, wherein generating the visual fusion feature comprises generating the visual fusion feature classified into a pointing response with coordinated eye gaze, a pointing response without coordinated eye gaze, and no pointing response.

15. The method of claim 14, wherein learning the pointing gesture with coordinated eye gaze comprises learning the pointing gesture with coordinated eye gaze using a loss function for classification of the visual fusion feature and a loss function derived by the self-supervised learning scheme.

16. The method of claim 15, wherein the self-supervised learning scheme learns class-specific features and domain-invariant features and trains an entire network in an end-to-end manner.
